(19) United States
(12) Patent Application Publication
(10) Pub. No.: US 2014/0297420 A1
(43) Pub. Date: Oct. 2, 2014

(54) INTERACTIVE SHOPPING SYSTEM FOR USE WITH MOBILE COMPUTING DEVICES

(71) Applicant: Kyle Patel, Mason, OH (US)

(72) Inventor: Kyle Patel, Mason, OH (US)

(21) Appl. No.: 13/855,672

(22) Filed: Apr. 2, 2013

(51) Int. Cl. G06Q 30/06; G06Q 30/02

(52) U.S. Cl. CPC G06Q 30/0633; G06Q 30/0267; G06Q 30/0281
USPC 705/14.64

(57) ABSTRACT

A computer-implemented system links product information, location and sales information with mobile computing devices such as a smart-phone of a shopper. The shopper's smart-phone displays a route to the products in which she is interested by input to the application on his or her phone or mobile computing device. The shopper is efficiently mapped to the products in the most efficient order, and product and promotional sales information, such as instant coupons, are downloaded to the shopper's phone or device leading to an efficient shopping event without wasted time or missed sales or coupon opportunities.

### TECHNICAL FIELD

The invention relates to systems and methods of location-based shopping facilitated by in-store positioning and revenue-generating advertiser content downloaded to a mobile device such as a smart-phone.

### BACKGROUND OF THE INVENTION

In today's world, consumers are exposed to information overload while shopping. Mobile computing devices are capable of containing a multitude of user applications but none heretofore specifically help the user locate their desired items on a given shopping trip. Brick and mortar stores and shopping malls are replete with products and stores, as well as sales materials, promotions, signage and the like all aimed at attracting shopper attention. However, a determined shopper with a specific list of needed items is left to navigate through the myriad of stores and aisles to find a specific item, and only then start the product and price comparison. Malls, stores and other brick and mortar establishments are left hoping their consumers will find the products they need at the best price. Shoppers waste time wandering aisles looking for their desired products, often purchasing products they do not originally need or want. And advertisers do not have a way to target shoppers in malls and stores that are looking for their products.

And thus, there has been a rise in online shopping. Online shopping addresses many of these problems, making the shopping experience more convenient in general. But online shopping falls short on the purchase of certain products, e.g., shoes, clothing that consumers feel more comfortable buying after trying on or holding the product.

Accordingly, there continues to be a need for a system and method to allow shoppers to efficiently locate and purchase products from brick and mortar establishments while also allowing advertisers to target relevant product, price and promotional information to shoppers specifically interested in their product class.

### SUMMARY OF THE INVENTION

The invention meets the needs identified above by providing a computer-implemented system that links product information, location and sales information with mobile computing devices such as smart-phones of shoppers. The shopper inputs the products he or she wishes to see into the application on his or her phone or device. The shopper's smart-phone displays a route to the products. After the shopper is mapped to the products in the most efficient order, specific product and promotional information, such as instant coupons, are downloaded to the shopper's phone or device, leading to an efficient and successful shopping event.

In accordance with one aspect of the invention, a computer-implemented system for a shopper in a brick and mortar establishment such as a shopping mall, department or retail store, grocery or mass purchase club store is provided. The system comprises a computer server containing a product database having products, in-store locations for the products, and promotional information for the products. The computer server is capable of receiving and sending information to mobile computing devices and locating the mobile computing device within the brick and mortar establishment.

The system also includes a programmable microprocessor that facilitates receiving location information of a mobile computing device owned by the shopper and selection of the products desired for purchase. The microprocessor wirelessly identifies the products on the server along with the products' location, promotional and product information and sends it wirelessly to the mobile computing device in a way which allows the shopper to navigate directly to the products via directions displayed on the mobile computing device and to see said promotional and product information once reaching the products' location in the brick and mortar establishment. The microprocessor remains in wireless communication with the mobile computing device until the shopper completes locating all of the products desired by the shopper.

### BRIEF DESCRIPTION OF THE DRAWING

FIG. 1 is an architecture diagram of the system of the present invention.

### DETAILED DESCRIPTION OF THE INVENTION

The invention has a variety of embodiments to achieve an efficient and informative shopper experience in a brick and mortar establishment. These environments encompass individual stores, such as department stores, grocery stores, large mass merchandising club stores, shopping malls or outdoor strip malls such as those commonly referenced as outlet malls. Shoppers with the goal of purchasing a few specific items are typically required to navigate through stores and their aisles to locate products. Furthermore, shoppers must research product information, similar products, and promotional information separately. This can lead many hours of shopping for just a few items. The computer-implemented system provides the shopper's mobile computing device, such a smart-phone or other mobile phone, with an application interfacing with the particular mall or store server which may contain product information, location, and other information including but not limited to sales promotions and coupons that advertisers may want shoppers to have. Brick and mortar establishments may sell to advertisers the ability to push product promotions and information to shoppers inside their stores. Brick and mortar stores can maximize revenue by charging advertisers more or less depending on the order in which products are listed to shoppers and the frequency the product information is pushed. Brick and mortar establishments should be careful not to over-sell to ensure the system is user-friendly and allows shoppers to shop efficiently. Alternatively, the server can be administered by a third-party provider working in concert with the brick and mortar establishment.

Well known indoor positioning systems (IPS) utilize a wireless network of devices to continuously locate the position of an object inside of a building. IPS collects information from a given object with respect to existing wireless infrastructure (such as wireless internet or cellular network strength, radio waves, etc.) to triangulate the position of the object. U.S. Pat. No. 8,284,100 B2 presents one such method of tracking the indoor position of a mobile computing device. This technology can be integrated with the application programming interfaces of mobile smart-phones and other wireless mobile computing devices. Given the proliferation of such smart-phones across the general population, individuals may easily use this technology through their electronic devices. In a retail setting, this technology can be used to expedite and enhance a consumer's shopping experience buy guiding said consumer to products in the building using IPS.

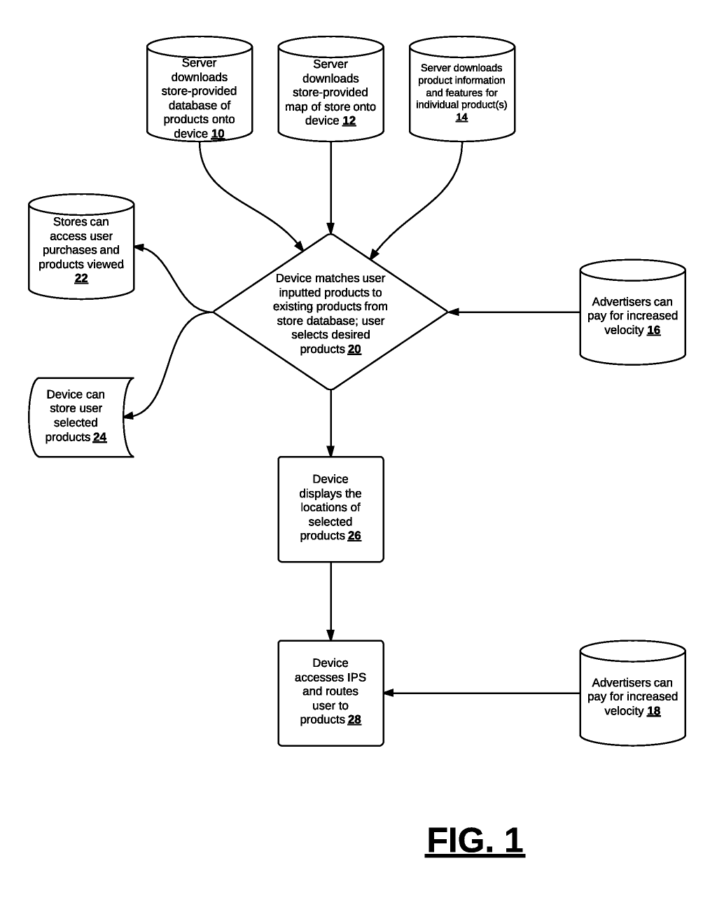

Turning now to FIG. 1, an architecture diagram of the computer-implemented system is depicted. The system has a computer server containing a product database 10 having products, store location for the products mapped for the store (product location database 12), promotional 16 and product 14 information for the features of the products. The computer server may be capable of receiving and sending information to mobile computing devices 20, such as smart-phones via standard network and microprocessor equipment. Additionally, the system may employ similar equipment and an IPS to locate and communicate with the mobile computing device within the brick and mortar establishment as needed. All such network and computer equipment is well known in the art.

The system also includes a programmable microprocessor that facilitates receiving location information of a mobile computing device 20 owned by the shopper. Such processing and IPS equipment is well known and a wide variety may be employed in the system described and claimed. The server and microprocessor should be able to interactively and wirelessly interface with the shopper's mobile computing device 20 so the products desired for purchase can be displayed, edited, and modified as the shopper moves about the brick and mortar establishment. The microprocessor wirelessly identifies the products on the server from the product database 10 along with the products' location (product location database 12), promotional and product information (product features database 14) and sends it wirelessly to the mobile computing device 20 in a way which allows the shopper to navigate directly to the products via directions displayed on the mobile computing device 20.

Preferably, the shopper can see the promotional and feature information once reaching the products' location in the brick and mortar establishment. Advertisers may pay for frequent and prioritized product promotions from database 16 and database 18. For example, when the shopper enters a store, he or she may interface with the server to identify several products desired, the system then downloads products from database 10 and product location from database 12, and IPS maps a route based on the shopper's current location. At this time, advertisers may include advertising and promotional information from database 16 on the products selected by the shopper. Type, frequency or velocity and timing may be determined based on advertiser payment. While the shopper routes to the desired products, additional promotional information including for example coupons can be pushed to the shopper as he or she approaches a particular product. The server via well known network and microprocessor equipment remains in communication with the mobile computing device until the shopper completes locating all of the products he or she desires. Advertisers can be charged more for having their product information made available higher in the list displayed on the shopper's mobile computing device 20.

Additionally, the system allows the shopper to modify her product list at anytime, and instantaneously modify the routing and product information displayed on the shopper's mobile computing device 20. Such modification capability allows the shopper to continue efficient shopping from anywhere in the store or shopping mall. Additional well known indoor positioning equipment may be used to enhance accurate routing especially within large shopping malls. And location and product information for databases 10 and 12 may be linked together from many stores when the brick and mortar establishment is a large shopping mall. Typically, an application can be used on the mobile computing device 20 to display locations of selected products 26 and routing or mapping to the products 28. The interactive application connects the mobile computing device 20 to the system of the invention and displays on the device products 26 and locations with a route 28. Product purchases 24 can be stored on the device 20 for the shopper's later convenience. Finally, brick and mortar establishments may store shopper purchasing decisions and products viewed in database 22. Such information could be sold for additional revenue.

Although a few implementations have been described in detail above, other modifications are possible. Moreover, other mechanisms for performing the system described herein may be used. In addition, the architecture diagram of FIG. 1 does not require the order shown, or sequential order, to achieve desirable results. Other steps may be provided or steps may be eliminated from the described flows. Accordingly, other system implementations are within the scope of the following claims.

What is claimed is:

1. A computer-implemented system for a shopper in a brick and mortar establishment comprising:
a) a computer server containing a product database having products, store location for said products, promotional and information for said products; said computer server capable of receiving and sending information to mobile computing devices and locating said mobile computing device within said brick and mortar establishment; and
b) a programmable microprocessor that facilitates receiving location information of a mobile computing device owned by said shopper and selection of said products desired for purchase; said microprocessor wirelessly identifies said products on said server along with said products' location, promotional and information and sends it wirelessly to said mobile computing device in a way which allows said shopper to navigate directly to said products via directions displayed on said mobile computing device, and to see said promotional and information once reaching said products' location in said brick and mortar establishment; said microprocessor remains in communication with said mobile computing device until said shopper completes locating all of said products desired by said shopper.

2. The system of claim 1 wherein said microprocessor is capable of receiving input from said shopper modifying said products and adjusting said directions according to said shopper input.

3. The system of claim 1 wherein said promotional product information includes coupons capable of being instantly downloaded to said mobile computing device.

4. The system of claim 1 wherein said microprocessor is capable of downloading and storing shopper input from said mobile computing device for studying purchasing decisions by said shopper.

5. The system of claim 1 wherein said promotional information on said computer server can be manipulated in terms of order in which it is downloaded to said mobile computing device.

6. The system of claim 1 wherein said promotional information on said computer server can be manipulated in terms of the frequency in which it is downloaded to said mobile computing device.

7. The system of claim 1 further includes an enhanced Indoor Positioning System to facilitate said mobile computing device and said products locations within said brick and mortar establishment for accurate location of said products.

8. The system of claim 1 wherein said products information includes product price.

9. A mobile computing device containing an application facilitating use of a system according to claim 1.

10. The device of claim 9 wherein said device is a smart-phone.
